(19) United States
(12) Patent Application Publication
(10) Pub. No.: US 2017/0328546 A1
(43) Pub. Date: Nov. 16, 2017

(54) METHODS AND SYSTEMS FOR MOUNTING LED LIGHT MODULES

(71) Applicants: Aaron Gorman, New Braunfels, TX (US); Glenn Freeman, San Antonio, TX (US)

(72) Inventors: Aaron Gorman, New Braunfels, TX (US); Glenn Freeman, San Antonio, TX (US)

(21) Appl. No.: 15/592,401

(22) Filed: May 11, 2017

Related U.S. Application Data
(60) Provisional application No. 62/334,597, filed on May 11, 2016.

(51) Int. Cl. F21V 21/005; G09F 13/22; F21V 21/096; F21V 17/12; F21Y 2115/10

(52) U.S. Cl. CPC F21V 21/005; F21V 21/096; F21V 17/12; G09F 13/22; F21Y 2115/10; G09F 2013/222

(57) ABSTRACT

Systems and methods for mounting light emitting diode (LED) lighting modules in a cabinet or box sign. Mounting systems include components for mounting LED lighting modules to cabinet sign support structures within the interior structure of the cabinet or box sign. LED lighting modules include LED light bars having one or more LED lighting modules mounted thereon. Each mounting system includes a component for attaching or connecting the mounting system to a support structure within the cabinet or box sign, as well as a component for attaching or connecting one or more LED lighting modules mounted onto a light bar to the mounting system.

### CLAIM OF PRIORITY TO PRIOR APPLICATIONS

This application claims the benefit of prior filed co-pending U.S. Provisional Application Ser. No. 62/334,597, filed on May 11, 2016, entitled “Methods and Systems for Mounting LED Light Modules.” By this reference, the entire disclosure, including the claims and drawings, of U.S. Provisional Application Ser. No. 62/334,597, is incorporated into the present disclosure as if now set forth in its entirety.

### BACKGROUND

### 1. Technical Field

The present invention relates to light emitting diode (LED) lighting systems and, more particularly, systems and methods for mounting LED light modules in a cabinet sign.

### 2. General Background & Related Art

In commercial signage, linear fluorescent lamps were often mounted in a parallel fashion in what are known in the industry as cabinet signs or box signs. In many instances, LED light sources have replaced the traditional fluorescent light sources used in lighting cabinet signs. Motivation for replacing fluorescent lighting with LED light sources includes greater efficiency, lower operational cost, and longer life for LED light sources. However, mounting of LEDs in a cabinet sign or box sign poses unique challenges.

Linear fluorescent lamps have typically been mounted in a parallel fashion in cabinet signs, either vertically or horizontally. The sides or the tops and bottoms of the cabinet signs provided mounting points for the sockets used to power the linear fluorescent lamps. Depending on their configuration, mounting of LED light sources is typically performed in a different manner, especially with respect to LED light modules in the form of LED light bars.

In some instances, the internal support structure present in a cabinet sign may interfere with the lighting of the sign face. More particularly, structural components such as I-beams, C-channels, rectangular tubing, and the like, which are used to form an internal support structure for cabinet signs, can cause shadowing or non-uniformity of lighting on the sign face, depending on the placement of the light source and the type of light source being used.

Accordingly, needs have long remained in the art for a system or method that will overcome the shadowing or non-uniformity of lighting which may occur on the face of a cabinet sign when using one or more LED light modules in a cabinet sign while also overcoming many of the other challenges and obstacles that are presented by the field of art. In conjunction with this is the need to provide suitable systems and methods for mounting LED light modules so that shadowing on the sign face is minimal or does not occur at all.

### SUMMARY OF THE PRESENT INVENTION

It is a fundamental object of the disclosed systems and methods to improve over the prior art, including providing mounting systems for LED light modules which minimize or prevent shadowing or non-uniformity of lighting on the face of a cabinet sign. It is a further object to provide such mounting systems such that they are easy to assemble, install, connect, maintain, and troubleshoot, as well as being more reliable, affordable, efficient, versatile, effective, interchangeable, and adaptable.

In fulfillment of the above and further objectives, the disclosed systems and methods provide for mounting one or more LED light modules in cabinet signs. Some embodiments utilize a mounting assembly having a bracket system configured for attachment of one or more LED light modules to cabinet sign support structures such as I-beams, for example.

It is a further object to provide a mounting assembly for mounting of an LED light module which utilizes magnetic attachment of the mounting assembly to a steel support structure in a cabinet sign, such support structure including, but not limited to, I-beams, C-channels, rectangular tubing, and the like.

It is a further object to provide a mounting assembly which utilizes C-channel structures configured for receiving one or more LED light modules, such C-channel structure further being configured for attachment to a structural support member incorporated in a cabinet sign using one or more braces.

It is a further object to provide a mounting system which includes a unitary bracket configured for the mounting of one or more LED light modules wherein the unitary bracket is capable of connecting with one or more such unitary brackets for mounting onto a structural support member incorporated in a cabinet sign. The features of the disclosed embodiments enable mounting LED light modules in a variety of orientations, such orientations necessarily including horizontal and vertical, as well as other orientations which may be necessitated according to need.

These and other objects are addressed by providing components, configurations, systems, subsystems, and methods that follow various teachings of the disclosed systems and methods that will be evident to those of skill in the art after reading and contemplating this specification and any drawings and claims that may be appended hereto or later supplemented or amended.

Many other objects, features, variations and advantages of the invention will be evident from a review of the further descriptions herein, particularly when reviewed by one of ordinary skill in the art with the benefit of the accompanying drawings, prior art, and any claims that may be associated with this specification.

### BRIEF DESCRIPTION OF THE DRAWINGS

FIG. 1 is a perspective view showing a mounting assembly 10.

FIG. 2 is a top plan view showing engagement of two mounting assemblies 10 with an I-beam 40.

FIG. 3 is front view showing two mounting assemblies 10, each having an LED light bar attached thereto and being mounted to an I-beam 40.

FIG. 4 is a partial rear perspective view showing mounting assembly 10 affixed to I-beam 40, and wherein LED light bar 50 is mounted to mounting assembly 10.

FIG. 5 is a perspective view of an alternate embodiment of mounting assembly 110.

FIG. 5A is a perspective view of an alternate embodiment of mounting assembly 110a.

FIG. 6 is a side elevation view showing LED light bars 50 mounted to an I-beam 40 using two mounting assemblies 110.

FIG. 7 is a side elevation view of two LED light bars 50 mounted to an I-beam 40 using a mounting assembly 110.

FIG. 8 is a partial side perspective view showing two LED light bars 50 mounted to an I-beam 40 using a mounting assembly 110.

FIG. 9 is a front elevation view of an alternate embodiment of the disclosed mounting system showing an LED light bar 50 mounted to an I-beam 40 using LED light bar mounting assembly 210.

FIG. 10 is a partial perspective view showing an LED light bar 50 mounted to an I-beam 40 using LED light bar mounting assembly 210.

FIG. 11A is a close-up partial perspective view showing a portion of LED light bar mounting assembly 210 onto which two LED light bars 50 are mounted.

FIG. 11B is a close-up partial perspective view of another portion of LED light bar mounting assembly 210 onto which two LED light bars 50 are mounted.

FIG. 12 is a front elevation view of an alternate embodiment of the disclosed mounting system showing an LED light bar 50 mounted to an I-beam 40 using LED light bar mounting assembly 310.

FIG. 13 is a partial perspective view showing an LED light bar 50 mounted to an I-beam 40 using LED light bar mounting assembly 310.

FIG. 14 is a partial perspective view more particularly showing the attachment of an LED light bar 50 mounted to LED light bar mounting assembly 310 as mounted on an I-beam 40.

FIG. 15 is a close-up partial perspective view showing a coupling point between two LED light module mounting assemblies 310 and positioning fasteners 360.

### DETAILED DESCRIPTION OF PREFERRED EMBODIMENTS

The following examples are included to demonstrate preferred embodiments of the disclosed mounting systems. It should be appreciated by those of ordinary skill in the art that the embodiments disclosed in these examples are thought to represent embodiments that function well in the practice of the inventions, and thus can be considered to constitute preferred modes for their practice. However, in light of the present disclosure, those of ordinary skill in the art should appreciate that many changes can be made in the specific embodiments disclosed while still obtaining a like or similar result without departing from the spirit and scope of the disclosed mounting systems.

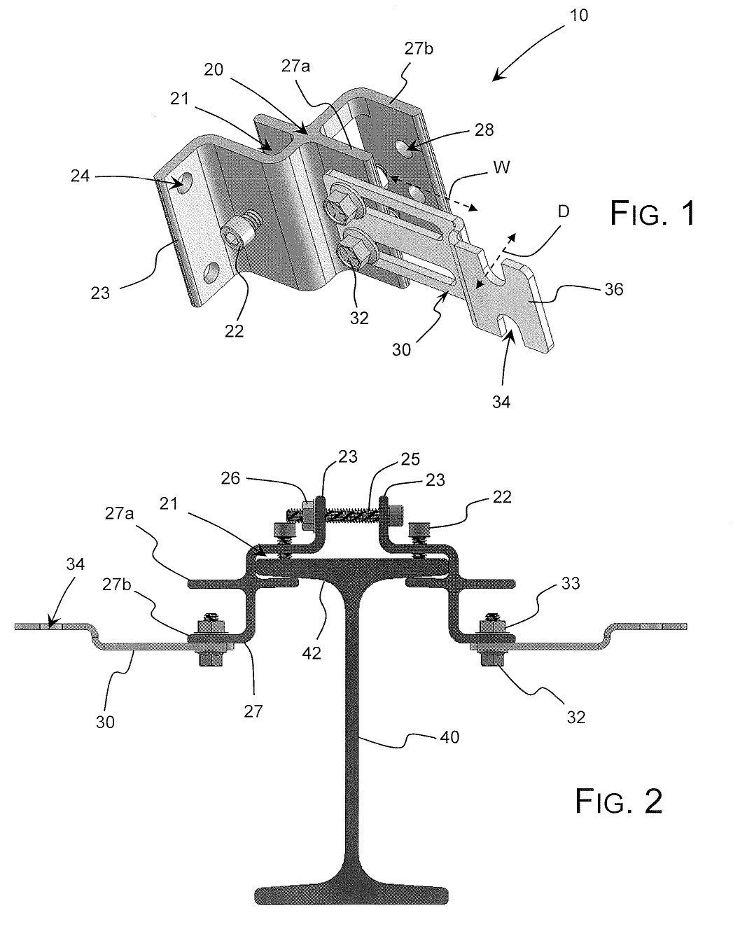

A better understanding of the disclosed LED light module mounting systems may be had by reading the description of the disclosed embodiments together with the figures described above. One preferred embodiment involves a system for mounting an LED light bar to a structural support member within a cabinet sign as is illustrated in FIGS. 1-4. LED light bars which may be mounted using the disclosed systems and methods include the RetroRayz LED Light Bar system which is commercialized by General LED, Inc. For a better understanding of at least some of the types of light modules and light bar systems which may be used with the embodiments disclosed herein, reference is made to U.S. patent application Ser. No. 14/694,515, the entire disclosure of which is incorporated into the present disclosure.

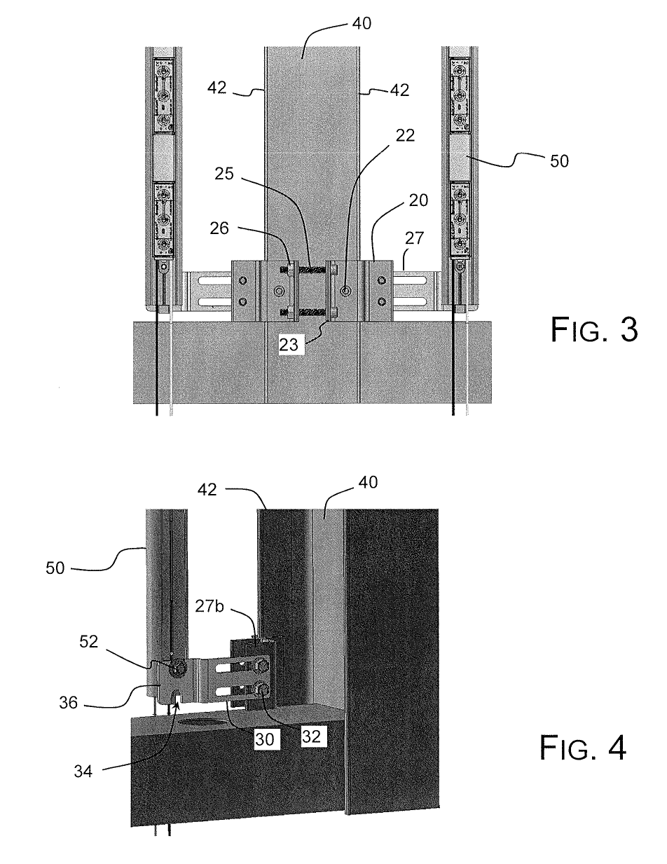

Turning first to FIG. 1, there is shown one embodiment of a light bar mounting assembly 10. It is contemplated that the embodiment illustrated in FIG. 1 would be used for mounting an LED light bar onto a structural support member within a cabinet sign. Mounting assembly 10 is preferably a two-piece assembly having a beam mounting bracket 20 and a mounting section, particularly a light bar mount section 30, which is configured to engage beam mounting bracket 20, as well as providing a mechanism for a mechanical connection with an LED light bar 50 (as shown in FIG. 4). Beam mounting bracket 20 is configured to be mounted onto a support structure within a cabinet sign as described in further detail below and as shown in FIG. 2. Beam mounting bracket 30 is shown to have a substantially curvilinear body.

Mounting of assembly 10 onto a structural support member such as an I-beam 40 (shown in FIG. 2) is accomplished in part by sliding a recessed section, particularly shown as flange slot 21, over an I-beam flange 42 (shown in FIG. 2). A fastener such as set screw 22 is positioned through a threaded opening in beam mounting bracket 20 and into the space created by flange slot 21. Tightening of set screw 22 helps secure beam mounting bracket 20 onto I-beam 40, more particularly onto I-beam flange 42, as fitted into flange slot 21 for holding mounting assembly 10 in place.

Also shown in FIG. 1 is light bar mount 30 which is configured for attachment to beam mounting bracket 20. Such attachment is generally at bar mount extensions 27a and 27b, both of which contain openings configured as extension fastener holes 28 being sized and shaped for accepting light bar mount fastener 32. For connecting light bar mount section 30 to beam mounting bracket 20, extension fastener holes 28 can be aligned with the openings, being shown as bar mount extension holes 33 in FIG. 1, with the extension fastener holes 28, having light bar mount fasteners 32 passing therethrough. Bar mount extensions 27a and 27b are shown to be in a parallel orientation with respect to one another and separated by a gap or space. Although FIG. 1 illustrates two bar mount extensions, it should be understood that other numbers of extensions, including one or more than two, could be substituted into the presently disclosed embodiment while performing substantially the same function.

Either of the two bar mount extensions 27a, 27b may be used for connection of beam mounting bracket 20 with light bar mount 30, depending on the necessary configuration of the LED light bar 50 when mounted in a cabinet sign. Additionally, light bar mount 30 may be positioned on either side of bar mount extension 27a or 27b, again as dictated by the necessary configuration of the LED light bar 50 mounted within a cabinet sign. This positioning of light bar mount 30 onto bar mount extension 27a or 27b will determine the depth (D) at which LED light bar 50 is mounted. Further adjustments may be made to the width (W) of light bar mount 30, depending on which side and to which bar mount extension 27a or 27b light bar mount 30 is attached. It is contemplated that in some embodiments of LED light bar mounting assembly 10, the width (W) and depth (D) may be fixed for known configurations.

Light bar mount 30 has standoff slots 34, shown in FIG. 1 as an upper and lower slot on light bar mount 30, opposite its connection point with beam mounting bracket 20. Standoff slots 34 are configured for accepting a light bar standoff 52 (as shown in FIG. 4) that is generally positioned on the back side of LED light bar 50 for the purpose of mounting LED light bar 50. Standoff slots 34 are configured as U-shaped cutout portions of standoff plate 36 and are sized to accept the shaft portion of light bar standoff 52. LED light bar standoff 52 is pre-installed on light bar 50, and includes a screw- or bolt-type head (preferably hexagonally shaped, although other shapes are contemplated) with a shaft that is installed into LED light bar 50. The shaft of light bar standoff 52 slides into the U-shaped standoff slot 34, and the head portion of light bar standoff 52 is sized such that it is not able to pass through standoff slot 34. This helps hold light bar 50 in place once mounted onto standoff plate 36. More particularly, once mounted, the main body portion of light bar 50 is positioned on one side of standoff plate 36, and the head portion of light bar standoff 52 will be positioned on the opposite side of standoff plate 36 such that the head portion of light bar standoff 52 is unable to pass through standoff slot 34.

FIG. 2 illustrates a top plan view of two mounting assemblies 10 being mounted to an I-beam 40. Each mounting assembly 10 is positioned such that flange slot 21 fits over I-beam flange 42. Set screw 22 can be tightened in order to secure mounting assembly 10 to I-beam 40.

The two mounting assemblies 10 are shown in FIG. 2 to be connected at their corresponding cap fastener plates 23. In accordance with the view shown in FIG. 1, cap fastener plate 23 has two openings being cap fastener holes 24, each of which are configured, particularly being sized and shaped, for receiving a cap fastener 25. Two cap fastener holes 24 are shown, but those of ordinary skill in the art will recognize that other suitable numbers of fastener holes may be used which perform equally to the illustrated embodiment. Cap fastener 25 is shown to pass through cap fastener hole 24 in each of the cap fastener plates 23 of the corresponding mounting assemblies 10. Cap fastener 25 is secured in place by cap fastener nut 26. In preferred embodiments, cap fastener 25 is a socket head cap screw, and cap fastener nut 26 is a self-locking nut. More preferably, cap fastener nut 26 is a self-locking flange nut. Those of ordinary skill in the art will recognize that other types of screws, nuts, or other fastener assemblies may be used which perform equally well.

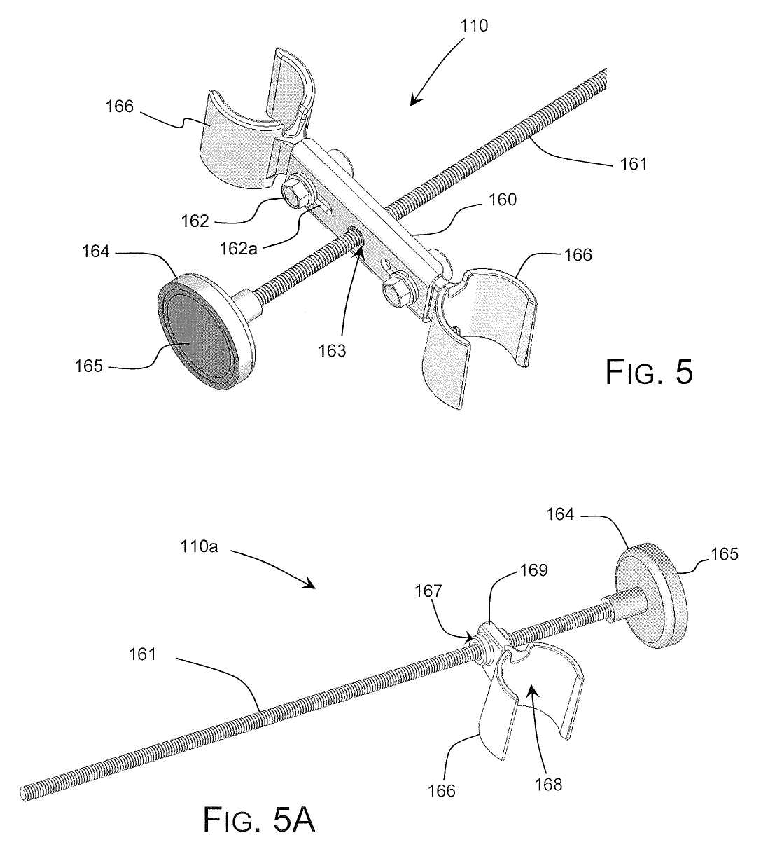

FIG. 3 is a front elevation view showing two mounting assemblies 10 affixed to I-beam 40. One LED light bar 50 is also shown installed in a vertical position on each mounting assembly 10. Each mounting assembly 10 is affixed to I-beam 40, particularly being affixed to I-beam flange 42 substantially as shown in FIG. 2. Each mounting assembly 10 is also shown connected to one another by cap fastener 25 running through cap fastener plate 23 on each of the mounting assemblies 10, substantially in the manner shown in FIG. 2.

FIG. 4 is a rear perspective view showing the mounting of LED light bar 50 to mounting assembly 10. Light bar standoff 52 is integrated with LED light bar 50 and aids in the mounting of LED light bar 50 to mounting assembly 10 for placement and use in a cabinet sign. Standoff plate 36 has two standoff slots 34, one on top and one directly below it. Standoff slots 34 are shown to be configured as U-shaped cutout portions of light bar mount 36. Standoff slot 34 is capable of receiving light bar standoff 52 for mounting LED light bar 50, as shown in FIG. 4, particularly being sized and shaped to receive the shaft portion of light bar standoff 52. LED light bar standoff 52 is pre-installed on light bar 50, and includes a screw- or bolt-type head (preferably hexagonally shaped) with a shaft that is installed into LED light bar 50. The shaft of light bar standoff 52 slides into the U-shaped standoff slot 34, and the head portion of light bar standoff 52 is sized such that it is not able to pass through standoff slot 34 when the shaft portion of light bar standoff 52 is positioned in standoff slot 34. This helps hold light bar 50 in place once mounted onto light bar mount 36 as previously described.

Turning now to FIG. 5, there is shown an alternate embodiment of an LED light bar mounting assembly 110. The main body of mounting assembly 110 includes crossbar section 160 having two ends with a main body portion therebetween. Light bar mounting assembly 110 includes light bar holders 166 at each end along the longitudinal axis of crossbar 160. In preferred embodiments of mounting assembly 110, crossbar 160 is constructed of metal, most preferably aluminum, and light bar holder 166 is preferably constructed of plastic or sheet metal. Those of ordinary skill in the art will recognize that crossbar 160 and light bar holder 166 may be constructed of other materials than metal while still being within the spirit and scope of the disclosed embodiments.

Light bar holders 166 are sized and shaped so as to allow them to “snap” onto LED light bars 50 for purposes of mounting. More particularly, light bar holders 166 have a concave or somewhat U-shaped open portion 168 for receiving the main body portion of LED light bars 50. Light bar holders 166 are sized and shaped such that they maintain a tight “grip” on LED light bars 50 when snapped onto LED light bars 50. It is contemplated that light bar holders 166 may be laterally adjustable through use of positioning screws 162 located on crossbar 160.

Proximate to each end of crossbar 160 are openings 162a through the main body portion of crossbar 160 through which positioning screws 162 pass. Openings 162a may be shaped as slots as illustrated in FIG. 5, or they may alternately be circular in shape, or any other shape that performs substantially the same function. Light bar holders 166 include a tab 169 (shown in FIG. 5A) having an opening, configured as light bar holder insert 167, which is sized and shaped to receive a positioning screw 162 passing therethrough. The opening in tab 169 can be aligned with either opening 162a located on crossbar section 160 such that a fastener 162 passes through both tab 169 and opening 162a to secure the position of light bar holder 166. When positioning screws 162 are tightened, the lateral position of light bar holders 166 is maintained. By loosening positioning screws 162, the lateral position of light bar holders 166 may be slightly adjusted along the longitudinal axis of crossbar 160, if necessary, depending on the LED light bar mounting configuration which is required in a particular circumstance for those embodiments that have slot-shaped openings 162a. Positioning screws 162 can then be tightened once the lateral position of light bar holders 166 is established based on the particular necessary lighting configuration. It should be recognized that different types of fasteners, other than positioning screws 162, may be used. For example, a bolt and nut assembly may be used instead of positioning screws 162 while still performing substantially the same.

Located substantially midway along the length of crossbar 160 is crossbar insert 163. As shown in FIG. 5, crossbar insert 163 is a threaded round opening configured, particularly being appropriately sized and shaped, for receiving rod 161. Rod 161 is preferably a threaded galvanized steel rod, although other materials may be used which can perform substantially the same function. On one end of rod 161 is steel cup 164, cup 164 preferably being threaded onto rod 161. Steel cup 164 is configured, particularly being appropriately sized and shaped, to hold a magnet 165. As shown in FIG. 5, magnet 165 is preferably a disk-shaped magnet having at least one substantially flat outer surface which is the surface facing away from crossbar 160. In preferred embodiments of mounting assembly 110, magnet 165 is a strong, permanent magnet, most preferably a rare earth magnet. Both magnet 165 and steel cup 164 preferably are nickel-plated. Those of ordinary skill in the art will recognize that magnet 165 and steel cup 164 may be constructed of other materials which can perform substantially the same function.

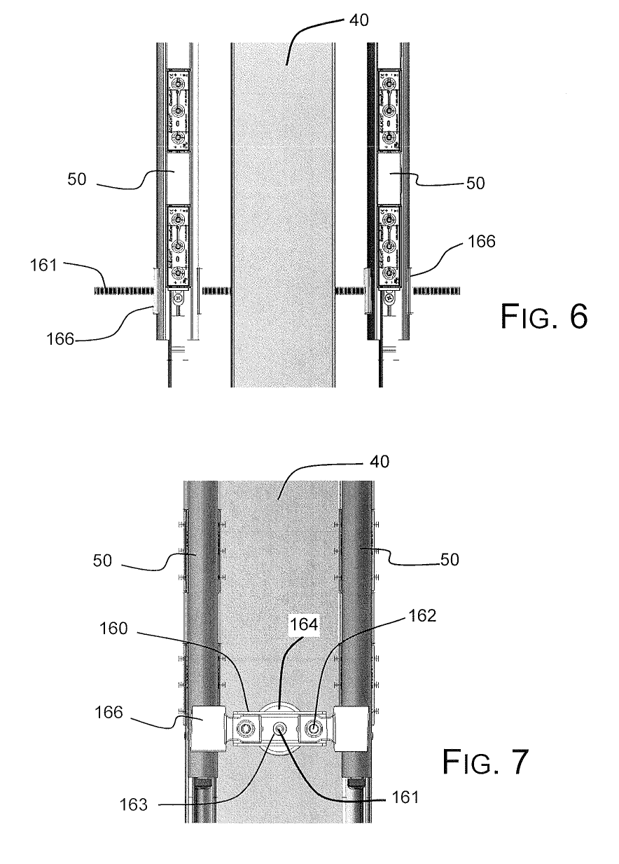

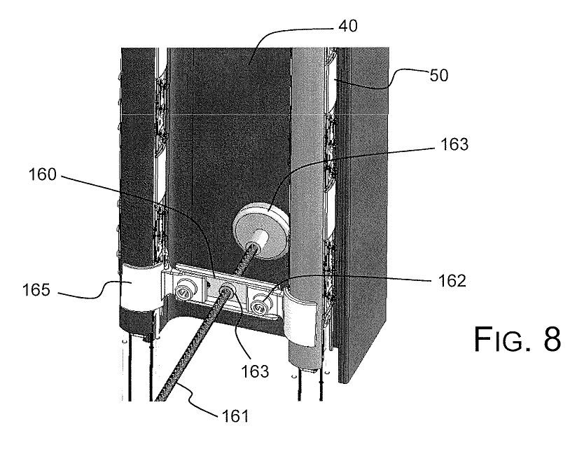

Turning now to FIGS. 6-8, there are shown two LED light bars 50 mounted to a structural support member such as an I-beam 40 using mounting assemblies 110. FIG. 6 is a front elevation view showing two mounting assemblies 110, in which two LED light bars 50 are mounted in light bar holders 166 in a mounting configuration with I-beam 40.

FIG. 7 is a side elevation view also showing two LED light bars 50 mounted to I-beam 40 using one mounting assembly 110. Magnet 165 positioned in steel cup 164 holds mounting assembly 110 to I-beam 40. Light bar holders 166 are configured such that they are capable of snapping onto the curved surface of LED light bars 50, such surface being opposite the side which incorporates the LED lamps.

FIG. 8 is a side perspective view showing two LED light bars mounted to I-beam 40 using mounting assembly 110. Magnet 165 is magnetically attached to I-beam 40 which holds mounting assembly 110 in place after assembly and mounting. The depth-wise position of light bar holders 166 can be finely adjusted using rod 161. As described above, rod 161 is threaded through crossbar insert 163. More particularly, by spinning crossbar 160, or conversely turning rod 161, the location of light bar holders 166 relative to the placement of magnet 164 on I-beam 40 can be adjusted, either toward I-beam 40 or away from it, depending on which way crossbar 160 is turned on threaded rod 161, or conversely which direction rod 161 is turned within crossbar insert 163.

Although FIGS. 6-8 show the use of mounting assembly 110 on an I-beam 40, given that magnet 164 holds mounting assembly 110 to the surface of the structural support member on which the mounting is accomplished, mounting assembly 110 may also be used on other structural support members having different shapes, and that are constructed of steel, for the purpose of mounting LED light bars 50. For example, it should be understood that steel structures forming I-beams, C-channels, rectangular tubing, and others may serve as an attachment surface for use with mounting assembly 110 for mounting LED light bars 50 within a cabinet sign.

FIG. 5A illustrates an alternate embodiment designated as mounting assembly 110a. As is shown in FIG. 5A, mounting assembly 110a includes some of the same components as mounting assembly 110 as shown in FIG. 5, with the notable exception being that mounting assembly 110a does not incorporate the use of a crossbar. Instead, light bar holder 166 is attached directly to threaded rod 161 via light bar holder insert 167 located on tab 169. Light bar holder insert 167 is a threaded opening on tab 169 for receiving rod 161 in a threaded engagement. In most all other aspects, mounting assembly 110a performs in a similar manner as described with reference to mounting assembly 110. For instance, mounting assembly 110a incorporates steel cup 164 which is configured to hold magnet 165 for attaching mounting assembly 110a to a steel support structure used within a cabinet sign.

Light bar holder 166, as shown in FIG. 5A, performs as described above with reference to mounting assembly 110, wherein light bar holder 166 is sized and configured such that an LED light bar 50 can be snapped into the open portion 168 of light bar holder 166 for purposes of mounting the LED light bar 50. The position of light bar holder 166 is adjustable relative to steel cup 164 and magnet 165, and accordingly the structural support member to which mounting assembly 110a is attached, by threading or unthreading light bar holder 166 on rod 161. This can be accomplished by turning light bar holder 166 clockwise or counterclockwise on rod 161.

Additionally, once an LED light bar 50 is engaged with mounting assembly 110a, the general position of the LED light bar 50, and consequently the position of mounting assembly 110a, may be adjusted simply by moving or sliding magnet 165 to a different location on the structural support member to which magnet 165 has been placed. It is contemplated that use of more than one mounting assembly 110a will provide greater flexibility in positioning multiple light bars inside a cabinet sign structure, as would be evident to those of ordinary skill in the art.

Although FIG. 5A shows only one light bar holder 166 threaded onto rod 161, it should be understood that more than one light bar holder 166 may be threaded onto rod 161 for mounting more than one LED light bar 50, depending on the necessary lighting configuration. Similar to mounting assembly 110, it should be understood that mounting assembly 110a may be used with structural support members having different shapes, and that are constructed of steel, for the purpose of mounting LED light bars 50. For example, it should be understood that steel structures forming I-beams, C-channels, rectangular tubing, and others may serve as an attachment surface for use with mounting assembly 110a for mounting LED light bars 50 within a cabinet sign.

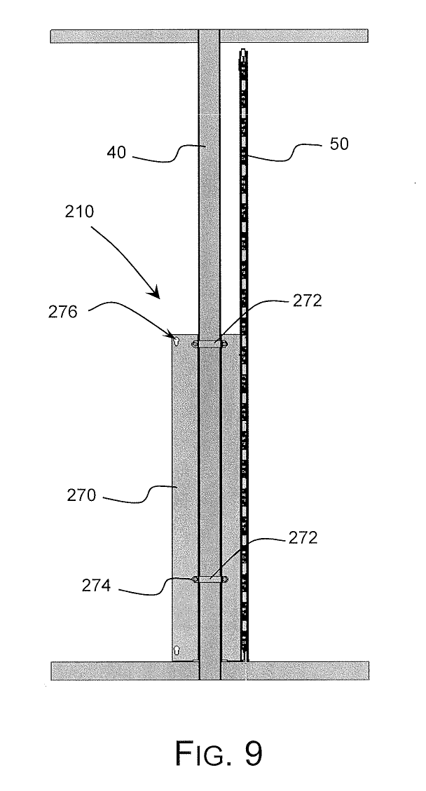

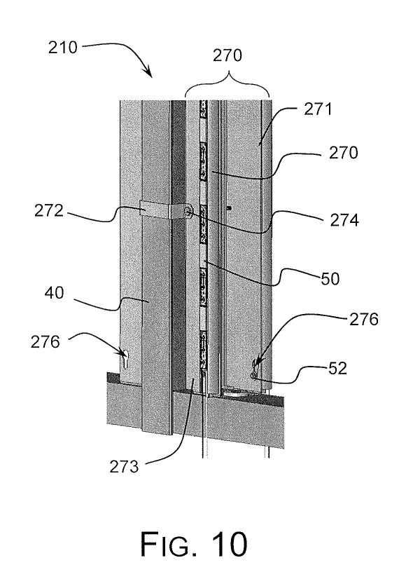

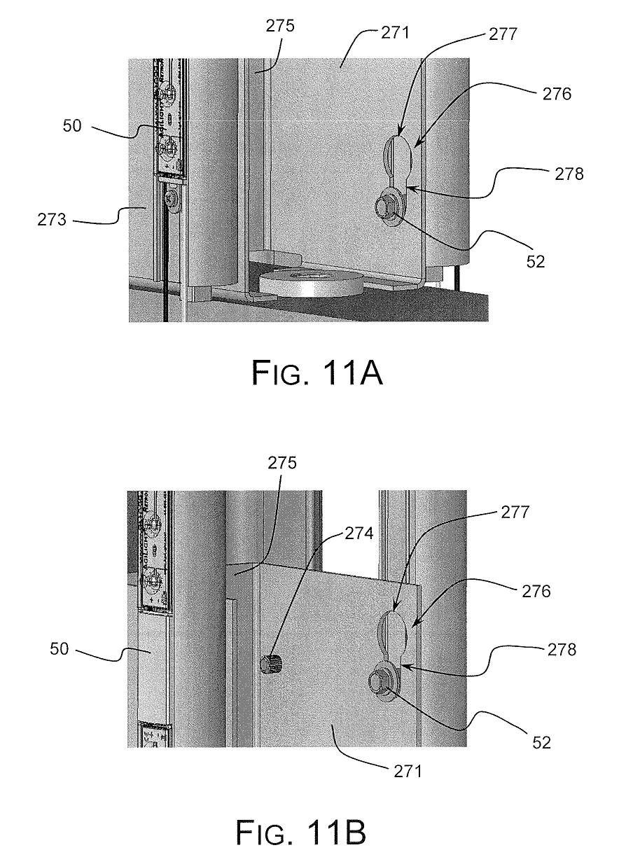

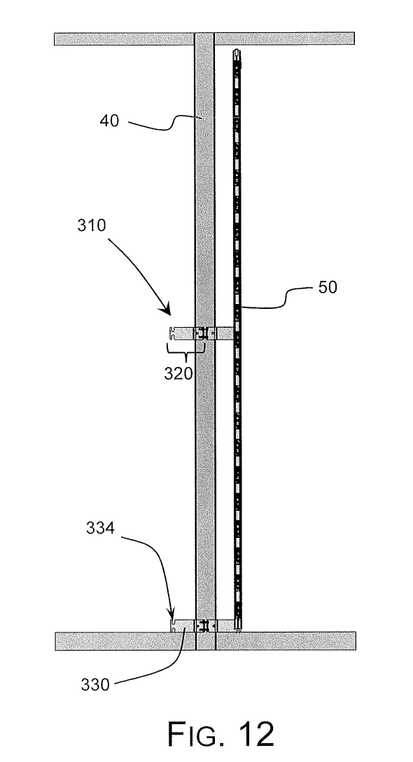

FIGS. 9-11B illustrate another alternate embodiment of the LED light bar mounting system represented by mounting assembly 210. FIG. 9 shows a view of some of the major components of mounting assembly 210, including C-channel 270 and brace 272. C-channel 270 is shown therein affixed to a structural support member, such as an I-beam 40, using braces 272 for attachment of C-channel 270 to I-beam 40. LED light bar 50 is also shown mounted onto I-beam 40, the details of which are more particularly shown in FIGS. 10-11. Two C-channels 270 may be mounted per I-beam 40 as shown, although it should be understood that depending on the length of I-beam 40, more than two C-channels 270 may be mounted thereon.

As shown in FIG. 10, LED light bar 50 is mounted in C-channel 270. C-channel 270 is shown to have Brace 272 is used in order to secure C-channel 270 to I-beam 40. Brace 272 is preferably of a particular size and shape so as to fit securely around at least a portion of the perimeter of I-beam 40. Attachment of brace 272 to C-channel 270 occurs via brace fasteners 274 passing through openings in brace fastener 274 and side walls 271, 273, with one brace fastener 274 on each side of the vertical portion of I-beam 40. In preferred embodiments of LED light bar mounting assembly 210, brace fastener 274 is a push-type fastener having a ribbed shank and a head of greater diameter than the ribbed shank, more commonly referred to as a Christmas tree clip. No tools are required to install such fasteners as they may be pushed into place, with the ribs on the shank helping to secure the position of the fastener once in place. It will be understood by those of skill in the art that other fastener types may be used and still be within the scope of the disclosed system.

Mounting of LED light bar 50 to C-channel 270 is accomplished through the use of light bar standoffs 52 and standoff slots 276, as shown in FIG. 10, with close-up views of these components being provided in FIG. 11A and FIG. 11B. Standoff slot 276 is shown as a keyhole-type opening in C-channel 270, having a substantially circular opening 277 which allows passage of light bar standoff 52, particularly the head portion of light bar standoff 52. Below this, the substantially circular opening 277 becomes narrow and forming U-shaped slot 278 that is sized and shaped to receive the shaft of light bar standoff 52 but prevents the passage back of the wider head of light bar standoff 52. Particularly in FIG. 11B, brace fastener 274 is shown passing through an opening in side wall 271.

In FIGS. 11A and 11B, it is shown that C-channel 270 has two side walls 271, 273 and a base wall 275. Side walls 271 and 273 are shown in a substantially parallel orientation with one another. Base wall 275 is shown between side walls 271 and 273, base wall 275 being in a substantially perpendicular orientation to side walls 271 and 273. In this context, “substantially perpendicular” refers to the side walls 271 meeting base 275 with either square corners at the junction or somewhat rounded corners but wherein the majority portion of side walls 271 are at 90 degree angles to base wall 275.

Although FIGS. 9-11B show the use of mounting assembly 210 on an I-beam 40, it will be recognized based on the drawings and description herein, the features of mounting assembly 210 allow for its use with other types of structural support members, not only I-beams. For example, it should be understood that structural support members forming C-channels, rectangular tubing, and the like may serve as an attachment surface for use with mounting assembly 210 for mounting LED light bars 50. It will also be understood that mounting assembly 210 may also be used with structural support members constructed of various types of metal. Furthermore, it is contemplated that mounting assembly 210 may be scaled to fit many different shapes and sizes of structural support members which might be used in the construction of a cabinet sign.

Another alternate embodiment of the disclosed system is illustrated in FIGS. 12-15. As shown in FIG. 12, LED light module mounting assembly 310 is a unitary bracket system for mounting an LED light module such as LED light bar 50 mounted to a structural support member such as I-beam 40. More particularly, two unitary brackets 320 are shown coupled together on I-beam 40, with one mounting assembly 310 near the base of I-beam 40 and a second mounting assembly 310 substantially halfway up the vertical portion of I-beam 40, wherein each unitary bracket 320 has features for mounting LED light bar 50.

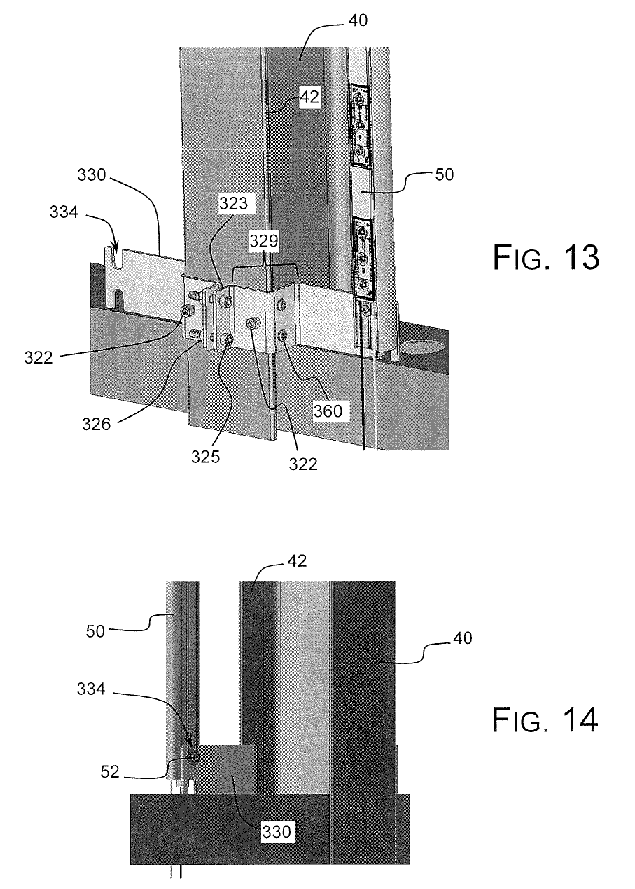

A closer view of two unitary brackets 320 coupled together and mounted on I-beam 40 can be seen in FIG. 13. Each unitary bracket 320 has a cap fastener plate 323, a bracket angle section 329, and a light bar mount section 330. Cap fastener plate 323 is shown to have an upper and lower cap fastener 325 passing through openings in cap fastener plate 323 that are sized and shaped to receive upper and lower cap fasteners 325, cap fastener plate 323 being configured for coupling two unitary brackets 320 together, as well as to help secure unitary brackets 320 to I-beam 40. Although cap fastener plate 323 is shown in FIG. 13 as employing two cap fasteners 325, it should be understood that cap fastener plate 323 may incorporate as few as one cap fastener 325, or more than two cap fasteners 325. Preferably, cap fastener 325 is a threaded screw or bolt onto which cap fastener nut 326 may be fixed for securing the coupling of the unitary brackets 320, as well as for securing the coupled unitary brackets 320 to I-beam 40. In preferred embodiments, cap fastener 325 is a socket head cap screw, and cap fastener nut 326 is a self-locking nut. More preferably, cap fastener nut 326 is a self-locking flange nut. Those of ordinary skill in the art will recognize that cap fastener 325 and cap fastener nut 164 may be constructed of other screw and nut types, or other different fastener types, which can perform substantially the same function.

As illustrated, bracket angle section 329 is positioned between cap fastener plate 323 and light bar mount section 330. Each face of bracket angle section 329 is positioned in a substantially perpendicular orientation with respect to the other. Bracket angle section 329 is sized and shaped to fit around a corner section of the support structure in the cabinet sign.

On one face of bracket angle section 329, there is shown set screw 322 which passes through an opening in bracket angle section 329. Tightening of set screw 322 helps to secure unitary bracket 320 to I-beam 40. On the other face of bracket angle section 329, there are shown two positioning screws 360 which help to temporarily hold unitary bracket 320 in a vertical position on I-beam 40 during the process of mounting unitary bracket 320 onto I-beam 40. Positioning screws 360 are drawn into contact with the inner surface of I-beam flange 42 when set screw 322 is rotated clockwise (or tightened). In preferred embodiments, positioning screws 360 are torx screws, although it will be understood that other screw or bolt types may be used which will be capable of performing this function. A close-up view of positioning screws 360 is shown in FIG. 15.

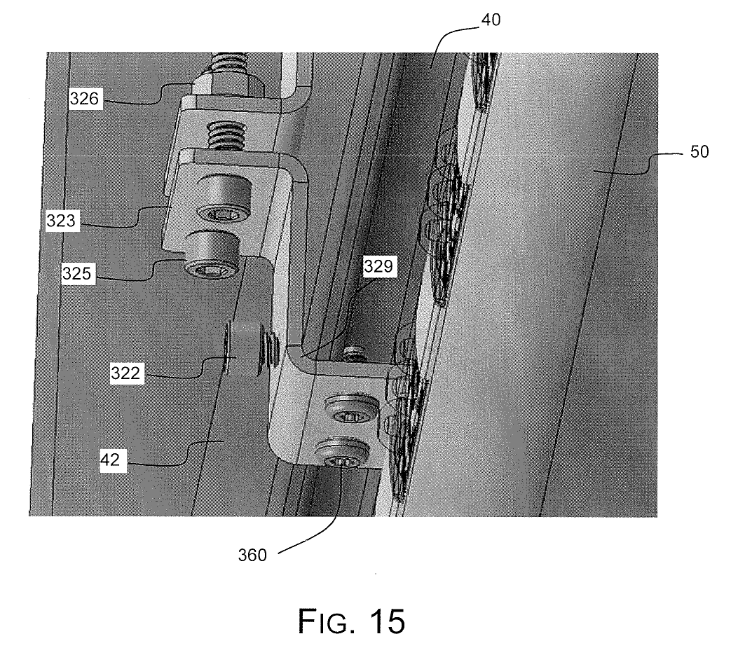

Unitary bracket 320 also includes light bar mount section 330. As shown in FIG. 13, light bar mount section 330 includes at least one, but preferably two, standoff slots 334. In the illustrated embodiment, standoff slot 334 is shown as a U-shaped cutout portion near the distal or outer end of light bar mount section 330. Standoff slot is sized and shaped to receive light bar standoff 52 for mounting LED light bar 50 to unitary bracket 320. This method of mounting light bar 50 is shown more particularly in FIG. 14. Therein it is shown that light bar standoff 52, which is integrated with and positioned on the rear side of light bar 50, is slid into standoff slot 334 when mounting light bar 50 so that the shaft portion of light bar standoff 52 fits into standoff slot 334. In this mounting configuration, standoff slot 334 is sized and shaped to accept the shaft portion of light bar standoff 52 but to prevent passage of the head portion of light bar standoff 52 therethrough.

Even though the foregoing embodiments represent the most preferred at present, those of ordinary skill in the art will recognize many possible alternatives that we have not expressly suggested here. While the foregoing written descriptions enable one of ordinary skill to make and use what is presently considered the best modes of the invention, those of ordinary skill will understand and appreciate the existence of variations, combinations, and equivalents of the specific embodiment, method, and examples herein. The drawings and detailed descriptions herein are illustrative, not exhaustive. They do not limit the invention to the particular forms and examples disclosed. To the contrary, the invention includes any further modifications, changes, rearrangements, substitutions, alternatives, design choices, and embodiments apparent to those of ordinary skill in the art, without departing from the spirit and scope of this invention, as defined by any claims included herewith or later added or amended in an application claiming priority to this present filing.

The invention covers all embodiments within the scope and spirit of such claims, irrespective of whether such embodiments have been remotely referenced here or whether all features of such embodiments are known at the time of this filing. Thus, the claims should be interpreted to embrace all further modifications, changes, rearrangements, substitutions, alternatives, design choices, and embodiments that may be evident to those of skill in the art. In any case, all substantially equivalent systems, articles, and methods should be considered within the scope of the present invention.

We claim:

1. A mounting system for mounting a light emitting diode (LED) light bar in a cabinet sign, the LED light bar having one or more LED lighting modules attached thereto, the LED light bar further having a standoff attached thereto, the standoff comprising a shaft portion and a head portion, said unitary mounting system comprising:
a) a bracket configured for attachment to a support structure within the cabinet sign; and
b) a mount section having a first end and a second end, wherein:
1) said first end is configured for connection with said bracket; and
2) said second end is configured for mounting the LED light bar to said mount section, whereby said second end receives the standoff of the LED light bar.

2. The mounting system as defined in claim 1 further comprising a recessed section positioned on said bracket, said recessed section comprising a slot that is sized and shaped to accept a flange portion of the support structure, said bracket having a threaded opening whereby a fastener passes through said threaded opening and into said slot, said fastener contacting the support structure within the cabinet sign for securing said bracket to the support structure.

3. The mounting system as defined in claim 1 further comprising a fastener plate positioned on said bracket, said fastener plate having at least one opening, said at least one opening being sized and shaped to receive a fastener passing therethrough, said fastener being for operatively connecting one bracket to another.

4. The mounting system as defined in claim 3 wherein said bracket further comprises two extensions being in a parallel orientation with each other and separated by a space, each of said extensions having at least one opening being sized and shaped to receive a fastener passing therethrough.

5. The mounting system as defined in claim 4 wherein said first end of said mount section includes at least one opening being sized and shaped to receive said fastener passing therethrough, said at least one opening on said first end of said mount section being alignable with said at least one opening on at least one of said extensions, wherein said fastener passes through said extension and said mount section for operatively connecting said mount section to said bracket.

6. The mounting system as defined in claim 1 wherein said second end of said mount section includes one or more U-shaped slots being sized and shaped to receive the shaft portion of the standoff attached to the LED light bar, and wherein the size of said one or more U-shaped slots prevents passage therethrough of the head portion of the standoff.

7. A mounting system for mounting a light emitting diode (LED) light bar in a cabinet sign, the LED light bar having a main body portion onto which one or more LED lighting modules are attached thereto, said unitary mounting system comprising:
a) a crossbar section having:
1) a first end, a second end, and a middle section between said first end and said second end;
2) an opening through said middle section, said opening comprising an insert located proximate to the center of a longitudinal axis of said crossbar section, and wherein said insert is threaded; and
3) two openings through said middle section, one of said openings being located proximate to said first end and the other of said openings being located proximate to said second end; and
b) at least one light bar holder, said at least one light bar holder being connected to said crossbar section at either of said first end or said second end, said at least one light bar holder having a concave portion being sized and shaped to receive the main body portion of the LED light bar; and
c) a threaded rod being threadable into said insert, said threaded rod having a cup threaded onto one end of said threaded rod, said cup supporting a magnet.

8. The mounting system as defined in claim 7 wherein said crossbar section is constructed of a metal material.

9. The mounting system as defined in claim 8 wherein said metal material is aluminum.

10. The mounting system as defined in claim 7 wherein said at least one light bar holder is constructed of a plastic material.

11. The mounting system as defined in claim 7 wherein said at least one light bar holder is constructed of sheet metal.

12. The mounting system as defined in claim 7 further comprising a tab positioned on said at least one light bar holder, said tab having an opening passing therethrough, said opening being sized and shaped to receive a fastener therethrough.

13. The mounting system as defined in claim 12 wherein said opening in said tab is alignable with one of said two openings on said middle section, wherein said fastener operatively connects said light bar holder to said middle section.

14. A mounting system for mounting a light emitting diode (LED) light bar in a cabinet sign, the LED light bar having one or more LED lighting modules attached thereto, said LED light bar further having a standoff attached thereto, said standoff comprising a shaft portion and a head portion, said unitary mounting system comprising:
a) two brackets coupled to one another, said two brackets each comprising:
1) a fastener plate having one or more openings, said one or more openings being sized and shaped to receive a fastener passing therethrough for operatively coupling said two brackets;
2) a mount section on each of said two brackets, said mount section being configured for attachment of the LED light bar, said configuration including one or more standoff slots:
3) an angle section on each of said two brackets, said angle section being positioned between said fastener plate and said mount section, said angle section having a first face and a second face, wherein:
i) said first face is proximate to said fastener plate and said second face is proximate to said mount section;
ii) said first and second faces are positioned in a substantially perpendicular orientation to one another; and
iii) each of said first face and said second face having at least one opening passing therethrough, said at least one opening being sized and shaped to receive a fastener passing therethrough.

15. The mounting system as defined in claim 14 wherein said angle section is sized and shaped to fit around a corner section of a support structure within the cabinet sign.

16. The mounting system as defined in claim 14 wherein said one or more standoff slots are sized and shaped to receive the shaft portion of the standoff and to prevent the passage therethrough of the head portion of the standoff.

17. A mounting system for mounting a light emitting diode (LED) light bar in a cabinet sign, the LED light bar having one or more LED lighting modules attached thereto, said LED light bar further having a standoff attached thereto, said standoff comprising a shaft portion and a head portion, said unitary mounting system comprising:
a) a C-channel having two side walls and a base wall, wherein said two side walls are positioned parallel to one another, and said base wall being positioned between said two side walls and being connected to said two side walls in a substantially perpendicular orientation;
b) one or more braces shaped and sized to fit around a support structure within the cabinet sign, each of said one or more braces having an opening sized and shaped to receive a fastener passing therethrough;
c) said two side walls having one or more openings positioned near an outer edge of each of said two side walls, said one or more openings being sized and shaped to receive the standoff; and
d) said two side walls having one or more openings positioned proximate to said connection to said base wall, each of said one or more openings being alignable with one of said one or more openings on said one or more braces, and said one or more openings in said two side walls being sized and shaped to receive said fastener passing therethrough.

18. The mounting system as defined in claim 16 wherein said one or more openings positioned near an outer edge of each of said two side walls comprises:
a) a partially circular section being sized and shaped to receive the head portion of the standoff; and
b) a substantially U-shaped section being sized and shaped to receive the shaft portion of the standoff, said substantially U-shaped section being sized to prevent the passage therethrough of the head portion of the standoff.
